(19) United States
(12) Patent Application Publication
(10) Pub. No.: US 2023/0333021 A1
(43) Pub. Date: Oct. 19, 2023

(54) TISSUE SAMPLE CARRIER FOR USE IN MULTISPECTRAL IMAGING

(71) Applicant: Leica Biosystems Newcastle, Ltd, Newcastle upon Tyne (GB)

(72) Inventor: Robert SYKES, Newcastle (GB)

(21) Appl. No.: 18/214,094

(22) Filed: Jun. 26, 2023

Related U.S. Application Data
(63) Continuation of application No. PCT/US22/11681, filed on Jan. 7, 2022.
(60) Provisional application No. 63/138,298, filed on Jan. 15, 2021.

(51) Int. Cl. G01N 21/64

(52) U.S. Cl. CPC G01N 21/6486; G01N 21/6456; G01N 2021/6482; G01N 2201/12723

(57) ABSTRACT

Tissue sample carriers for use in multispectral imaging are disclosed. In one aspect, a composition for fixing a tissue sample for multispectral imaging includes a carrier configured to protect and carry the tissue sample. The carrier has a first autofluorescence level when multispectral light strikes the tissue sample carried by the carrier. The composition further includes a pigment combined with the carrier and configured to reduce an autofluorescence property of the carrier such that the carrier has a second autofluorescence level when multispectral light strikes the tissue sample carried by the carrier. The second autofluorescence level is less than the first autofluorescence level.

### CROSS-REFERENCE TO RELATED APPLICATION(S)

This application claims the benefit of U.S. Provisional Patent Application No. 63/138,298, filed Jan. 15, 2021, the disclosure of which is incorporated herein by reference.

### BACKGROUND

### Technical Field

The described technology relates to tissue sample carriers, and in particular, carriers which can be used for multispectral imaging of tissue samples.

### Description of the Related Technology

Tissue samples can be analyzed under a microscope for various diagnostic purposes, including detecting cancer by identifying structural abnormalities in the tissue sample. Preparing a tissue sample for analysis under a microscope typically involves a number of processing steps that enable the tissue sample to be viewed under a microscope. One example processing step is the staining of the tissue sample which provides additional visual contrast to the cellular structure of the sample. Developments within the field of tissue sample diagnostics are enabling more advanced diagnostic processes, such as the ability to “virtually” stain tissue samples.

### SUMMARY

In one aspect, there is provided a composition for fixing a tissue sample for multispectral imaging, the composition comprising: a carrier configured to protect and carry the tissue sample, the carrier having a first autofluorescence level when multispectral light strikes the tissue sample carried by the carrier; and a pigment combined with the carrier and configured to reduce an autofluorescence property of the carrier such that the carrier has a second autofluorescence level when multispectral light strikes the tissue sample carried by the carrier, the second autofluorescence level being less than the first autofluorescence level.

The carrier can comprise a paraffin wax.

The carrier can be configured to infiltrate into the tissue sample in a liquid form and solidify such that the tissue sample is embedded therein to allow the tissue sample to be sectioned for the multispectral imaging.

The multispectral imaging can involve providing light to the tissue sample carried by the carrier within a range of frequencies, and the pigment can be further configured to reduce the first autofluorescence of the carrier in at least a part of the range of frequencies.

The second autofluorescence can have a frequency that is outside of a range of frequencies of the multispectral imaging.

The pigment can be further configured to absorb light having frequencies within a range of frequencies of the multispectral imaging.

The pigment can be configured so as to not substantially affect the properties of the carrier with regard to infiltrate and carry the tissue sample.

The carrier can be configured to fix and prevent degradation of the tissue sample during the multispectral imaging.

The reduction of the autofluorescence property of the carrier to the second autofluorescence level can be configured to improve clarity of an image signal collected from the tissue sample using the multispectral imaging.

In another aspect, there is provided a multispectral imaging system for acquiring an image of a tissue sample, the system comprising: a light source configured to emit multispectral light onto the tissue sample, the tissue sample configured to emit at least a portion of the multispectral light received from the light source; an imaging sensor configured to detect the multispectral light from the tissue sample and generate imaging data based on the detected multispectral light; and a processor configured to: determine that a carrier in which the tissue sample is carried comprises a pigment configured to reduce autofluorescence of the carrier, and in response to determining the carrier comprises the pigment, virtually stain the imaging data generated by the imaging sensor without processing the imaging data to reduce the autofluorescence of the carrier.

### BRIEF DESCRIPTION OF THE DRAWINGS

The features and advantages of the multi-stage stop devices, systems, and methods described herein will become more fully apparent from the following description and appended claims, taken in conjunction with the accompanying drawings. These drawings depict only several embodiments in accordance with the disclosure and are not to be considered limiting of its scope. In the drawings, similar reference numbers or symbols typically identify similar components, unless context dictates otherwise. The drawings may not be drawn to scale.

FIG. 1 is a block diagram illustrating an example multispectral imaging system in accordance with aspects of this disclosure.

FIG. 2 includes a number of images at different stages of imaging a tissue sample block and a tissue sample slide in accordance with aspects of this disclosure.

FIG. 3A illustrates a tissue sample embedded in a carrier block in accordance with aspects of this disclosure.

FIG. 3B illustrates a tissue sample placed on a tissue sample slide in accordance with aspects of this disclosure.

FIG. 4 illustrates an example multispectral imaging device in accordance with aspects of this disclosure.

FIG. 5A illustrates the properties of a composition for fixing a tissue sample for multispectral imaging in accordance with aspects of this disclosure.

FIG. 5B illustrates the properties of a composition for fixing a tissue sample for multispectral imaging having reduced autofluorescence in accordance with aspects of this disclosure.

FIG. 6 is an example method for manufacturing a carrier for multispectral imaging in accordance with aspects of this disclosure.

FIG. 7 is an example method for multispectral imaging of a tissue sample in accordance with aspects of this disclosure.

FIG. 8 is an example computing system which can implement any one or more of the imaging device, image analysis system, and user computing device of the multispectral imaging system illustrated in FIG. 1.

### DETAILED DESCRIPTION

The features of the tissue sample carrier for use in multispectral imaging, as well as related systems and methods, will now be described in detail with reference to certain embodiments illustrated in the figures. The illustrated embodiments described herein are provided by way of illustration and are not meant to be limiting. Other embodiments can be utilized, and other changes can be made, without departing from the spirit or scope of the subject matter presented. It will be readily understood that the aspects and features of the present disclosure described below and illustrated in the figures can be arranged, substituted, combined, and designed in a wide variety of different configurations by a person of ordinary skill in the art, all of which are made part of this disclosure.

The diagnosis of tissue samples may involve a number of processing steps to prepare the tissue sample for viewing under a microscope. While the traditional diagnostics techniques may involve staining a tissue sample to provide additional visual contrast to the cellular structure of the sample when viewed under a microscope, multispectral imaging (also referred to as multispectral optical scanning) can be used to create image data which can be “virtually” stained using an image analysis system. This enables the same sample to be virtually stained using stains having different properties, each which may provide additional visual contrast to different portions of the cellular structure.

Multispectral imaging may involve providing multispectral light to the tissue sample using a light source and detecting light emitted from the sample in response to the multispectral light using an imaging sensor. The tissue sample is typically embedded in a carrier that, among other things, helps fix the tissue sample and prevent or slow degradation of the tissue samples. The carrier may be implemented as a paraffin wax that is substantially transparent when viewed under a microscope. However, paraffin wax or other carriers (e.g., resin) may exhibit autofluorescence under at least a portion of the range of frequencies used for multispectral imaging. As used herein, the term “autofluorescence” may generally refer to emission of light by a material when exposed to light. Carrier autofluorescence may occur when exposed to certain frequencies of light which may at least partially overlap with the range of frequencies used for multispectral imaging.

The autofluorescence of the carrier may interfere with virtual staining or other image processing performed on the image data obtained from the multispectral scanning of the tissue sample. Accordingly, aspects of this disclosure relate to techniques and systems for reducing carrier autofluorescence, thereby improving, for example, the signal to noise ratio of the image data obtained during multispectral imaging of a tissue sample. One advantage of the techniques described herein is the reduction or elimination of unwanted autofluorescence produced by carriers during image data acquisition of multispectral imaging, thereby allowing for a clearer signal from desired targets in the tissue sample.

As described herein, aspects of this disclosure relate to the use of a carrier to which a pigment has been added during preparation. The pigment can be selected so as to not affect the properties of the carrier with regard to tissue processing and preparation while also reducing the autofluorescence of the carrier. The pigment is configured to prevent the production of autofluorescence by the carrier when excited by the light source used during multispectral imaging to cause excitation in the tissue sample. The reduction in carrier autofluorescence improves the clarity of the image signal collected from the sample without the need to spectrally filter out the unwanted signal (e.g., the frequencies/wavelengths associated with carrier autofluorescence).

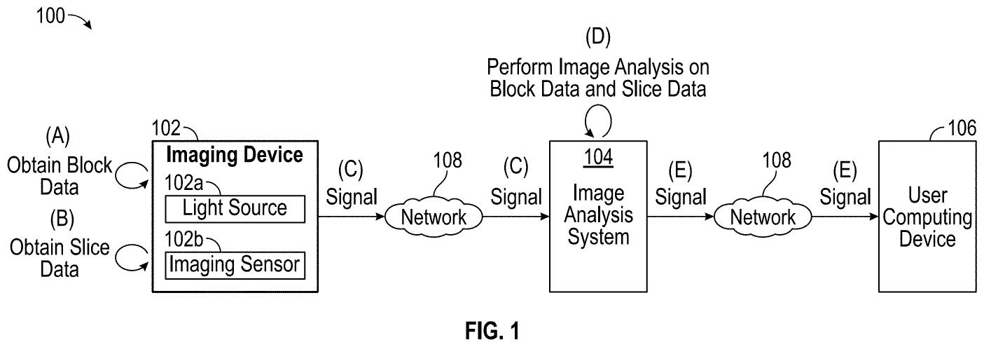

FIG. 1 is a block diagram illustrating an example multispectral imaging system 100 in accordance with aspects of this disclosure. With reference to FIG. 1, the multispectral imaging system 100 includes an imaging device 102, an imaging analysis system 108, a user computing device 110, and a network 112 connecting the imaging device 102 to the image analysis system 108. The imaging device 102 includes a light source 104 and an imaging sensor 106. In other implementations, the imaging device 102, image analysis system 108, and/or user computing device 110 may be integrated into a single

The imaging device 102 is configured to obtain tissue sample image data [A] from a tissue sample. For example, the light source 104 may be configured to emit multispectral light onto the tissue sample and the image sensor 106 may be configured to detect multispectral light emitted from the tissue sample. The multispectral imaging using the light source 104 can involve providing light to the tissue sample carried by a carrier within a range of frequencies. That is, the light source 104 may be configured to generate light across a spectrum of frequencies to provide multispectral imaging.

In certain embodiments, the tissue sample may reflect light received from the light source 104, which can then be detected at the image sensor 106. In these implementations, the light source 104 and the image sensor 106 may be located on substantially the same side of the tissue sample. In other implementations, the light source 104 and the image sensor 106 may be located on opposing sides of the tissue sample. The image sensor 106 may be further configured to generate image data based on the multispectral light detected at the image sensor 106. In certain implementations, the image sensor 106 may include a high-resolution sensor configured to generate a high-resolution image of the tissue sample. The high-resolution image may be generated based on excitation of the tissue sample in response to laser light emitted onto the sample at different frequencies (e.g., a frequency spectrum).

The imaging device 106 can transmit [B] and [C] a signal to the image analysis system 108 including the image data of the tissue sample. For example, the imaging device 106 may transmit [B] and [C] the image data to the image analysis system 108 over the network 112. The image analysis system 108 may be configured to perform image analysis on the image data [D]. For example, the image analysis system 108 may virtually stain the tissue sample using the image data produced during the multispectral imaging performed by the imaging device 102. The image analysis system 108 may also be configured to perform diagnostics on the image data, for example, detect whether any of the cells within the sample are cancerous. In some implementations, the diagnostics may involve one or more machine learning algorithms configured to diagnose the presence of one or more abnormalities within the tissue sample. The image analysis system 108 can provide the analyzed image data to the user computer device 110 to be displayed to a user. In certain implementations, the user computer device 110 can display an image of the virtually stained tissue sample and/or the results of the diagnostics performed by the image analysis system 108.

Prior to imaging by the multispectral imaging system 100, the tissue sample may be prepared using a number of different processing steps. For example, tissue sample preparation may include the following steps: obtaining the tissue sample, fixation (e.g., which may help stop or slow degradation of the sample), dehydration, clearing, carrier infiltration, embedding or blocking out, sectioning or slicing the blocked sample, and placing the slice on a slide. Those skilled in the art will reorganization that there are many variations and/or alternative techniques for tissue sample preparation which can be used to prepare a given tissue sample for multispectral imaging.

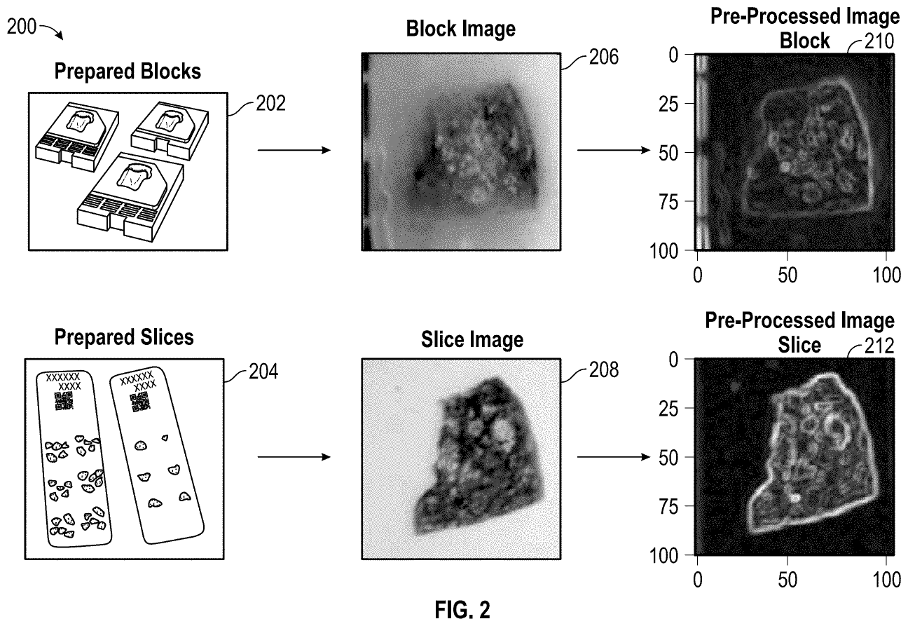

Once a tissue sample has been embedded in a block of the carrier, the tissue sample block may be imaged to generate a block image or the tissue sample may be sectioned into a thin slice and placed on a slide prior to imaging. FIG. 2 includes a number of images 200 at different stages of imaging a tissue sample block and a tissue sample slide in accordance with aspects of this disclosure.

Referring to FIG. 2, one or more tissue samples may be prepared for imaging and embedded within a set of carrier blocks at 202. One of the blocks may be imaged using the multispectral imaging system 100 to generate a block image 204. The block image 204 may correspond to the image data generated by imaging sensor 106. The image analysis system 108 may generate an extracted image 206 based on the block image 204. For example, the image analysis system 108 may be configured to extract image features from the block image 204 that may be useful for diagnostics in generating the extracted image 206.

In addition to imaging the sample embedded in a carrier block, the block may be segmented into one or more thin slices and affixed to one or more slides in order prepare slides 208 for multispectral imaging. The imaging device 102 of the multispectral imaging system 100 can be used to generate a slide image 210. The image analysis system 108 can then generate an extracted image 212 based on the slide image 210. Similar to the extracted block image 206, the image analysis system 108 may be configured to extract image features from the slide image 210 that may be useful for diagnostics in generating the extracted image 212.

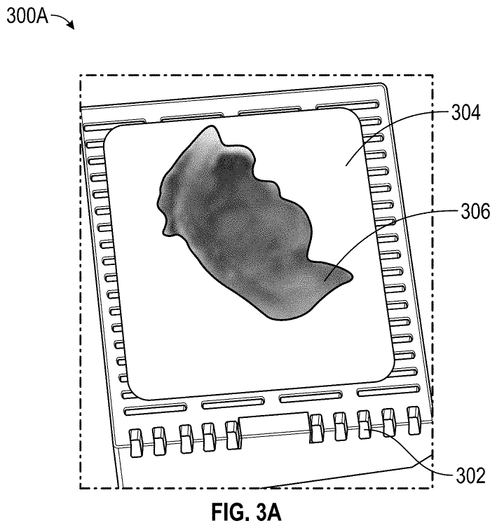

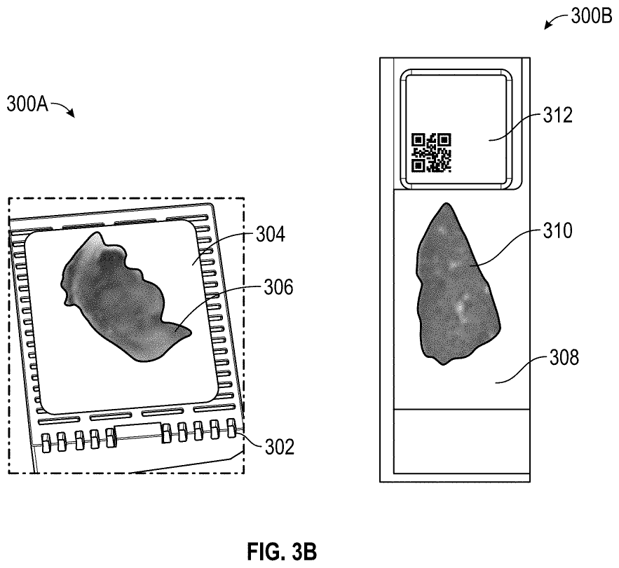

FIG. 3A illustrates a tissue sample embedded in a carrier block 300A in accordance with aspects of this disclosure. In particular, the carrier block 300A includes a support 302, a carrier 304, and a tissue sample 306.

FIG. 3B illustrates a tissue sample 310 placed on a tissue sample slide 300B in accordance with aspects of this disclosure. After being embedded in the carrier block 300A, the tissue sample 310 may be sectioned and placed on a slide 308. The tissue sample slide 300B can also include identification information 312, which may include human readable text and/or a computer readable code identifying the tissue sample 310.

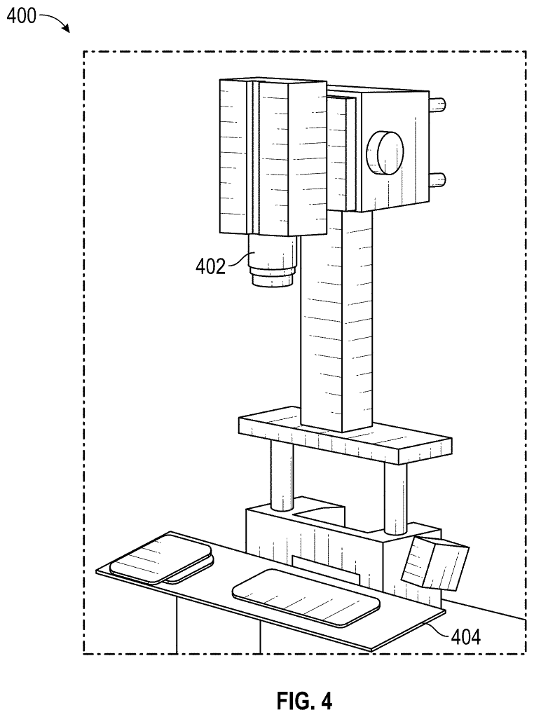

FIG. 4 illustrates an example multispectral imaging device 400 in accordance with aspects of this disclosure. In particular, the multispectral imaging device 400 includes an imaging device 402 configured to image a tissue sample 404. The imaging device 402 may include a light source and an imaging sensor, similar to the imaging device 102 of FIG. 1. The tissue sample 404 may be embedded in a carrier block or on a slide in accordance with the embodiments described in connection with FIGS. 2-3B. In order to obtain image data during a multispectral scan of the tissue sample 404, the tissue sample can be placed within a field of view of the imaging device 402, for example, directly below the imaging device 402.

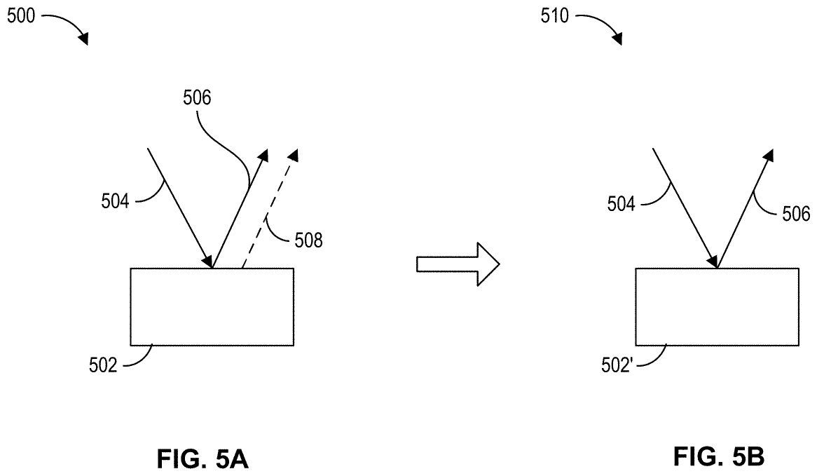

As described above, the carrier in which the tissue sample 404 is embedded may produce autofluorescence when exposed to at least some of the frequencies used for multispectral imaging. FIG. 5A illustrates the properties of a composition 500 for fixing a tissue sample for multispectral imaging in accordance with aspects of this disclosure. In particular, the composition 500 can include a carrier 502 configured to protect and carry a tissue sample for multispectral imaging. During imaging, multispectral light 504 is irradiated onto the composition 500, which reflects at least a portion of the received multispectral light so as to emit reflected multispectral light 506 which can be used to produce image data representative of the tissue sample. In addition, the carrier 502 may produce autofluorescence light 508 due to autofluorescence under at least a portion of the frequencies used for multispectral imaging. Because the autofluorescence light 508 is produced by the carrier 502 and not the tissue sample, the autofluorescence light 508 may obstruct or otherwise interfere with the visual contrast of the cellular structure of the tissue sample. The autofluorescence light 508 will be captured by the image data generated by the imaging device, and thus, may also affect the virtual staining of the tissue sample.

One technique for addressing at least some of the effects of the autofluorescence light 508 involves filtering the image data produced from the multispectral scan of the tissue sample. For example, the particular frequencies of light associated with autofluorescence of the carrier 502 may be known. Different carriers 502 may produce autofluorescence at different frequencies. Thus, the multispectral imaging system (e.g., the image analysis system 108) may filter out frequencies from the image data corresponding to the frequencies associated with autofluorescence of the carrier 502. However, filtering of specific frequencies from the image data requires additional processing of the image data and may involve loss of at least a part of the information representing the structure of the tissue sample embedded in the carrier 502.

Another technique for addressing autofluorescence of the carrier is to remove the carrier prior to imaging the tissue sample. For example, when using a paraffin wax as the carrier, the paraffin wax can be removed using xylene, isopropanol, or another xylene substitute as a clearing agent. However, without the carrier, the tissue sample may quickly degrade or otherwise become compromised. In addition, removing the carrier requires additional processing steps and potentially additional chemicals, which results in a more complicated workflow.

Aspects of this disclosure can address the autofluorescence of the carrier by adding a pigment to the carrier which reduces the autofluorescence of the carrier. FIG. 5B illustrates the properties of a composition 510 for fixing a tissue sample for multispectral imaging having reduced autofluorescence in accordance with aspects of this disclosure. With reference to FIG. 5B, the composition 510 includes a carrier 502′ which includes a pigment incorporated therein. The pigment is combined with the carrier 502′ and configured to reduce the autofluorescence property of the carrier 502′ when multispectral light strikes the tissue sample carried by the carrier 502′. In particular, during imaging multispectral light 504 is irradiated onto the composition 510, which reflects at least a portion of the received multispectral light so as to emit reflected multispectral light 506 which can be used to produce image data representative of the tissue sample.

Due to the presence of the pigment, the carrier 502′ may produce less or substantially no autofluorescence light 508, preventing the above-indicated obstruction and/or interference with the visual contrast of the cellular structure of the tissue sample. The use of the carrier 502′ including the pigment can also reduce or eliminate the need for filtering of frequencies associated with autofluorescence of the carrier 502. Moreover, by using the carrier 502′ including the pigment, the workflow for multispectral imaging of the tissue sample can be simplified compared to embodiments in which the carrier 502 is removed from the tissue sample prior to imaging.

The pigment may be selected to absorb light within a range of frequencies used by the multispectral imaging to reduce the autofluorescence of the carrier 502′. The pigment may be selected to absorb light having frequencies in at least the frequencies associated with autofluorescence of the carrier 502′. By reducing or eliminating the autofluorescence of the carrier 502′, the image data obtained during multispectral imaging will contain data representative of the cellular structure of the tissue sample without interference from the carrier 502′.

During preparation of a tissue sample for multispectral imaging, the carrier may be configured to infiltrate into the tissue sample in a liquid form and solidify such that the tissue sample is embedded therein to allow the tissue sample to be sectioned for the multispectral imaging. The pigment may be selected so as to not interfere with the ability of the carrier to infiltrate and carry the tissue sample.

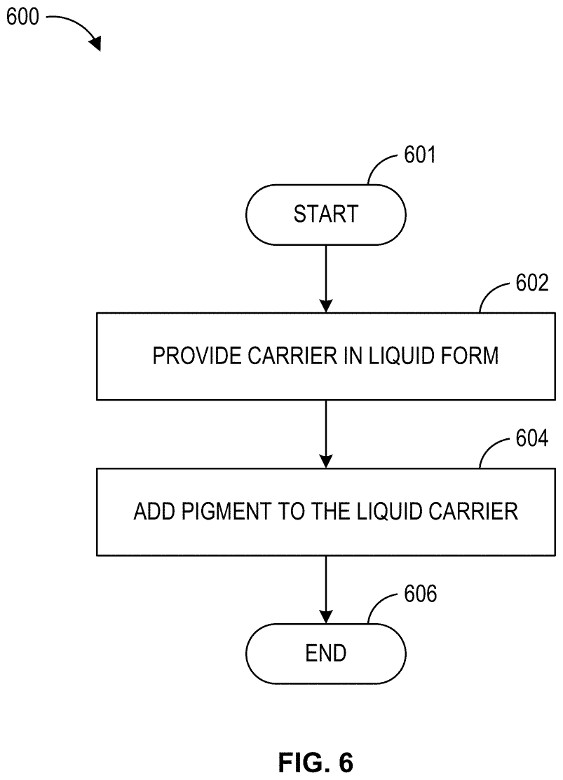

FIG. 6 is an example method 600 for manufacturing a carrier for multispectral imaging in accordance with aspects of this disclosure. The pigment may be combined with the carrier during manufacturing of the carrier via the method 600. The method 600 starts at block 601. At block 602, the method involves providing a carrier in liquid form. In some implementations, the carrier comprises a paraffin wax. At block 604, the method involves adding the pigment to the liquid carrier. For example, the pigment may be added to the carrier when the carrier is in liquid form and mixed with the carrier so as to be substantially evenly distributed within the carrier. The method 600 ends at block 606.

In some implementations, the multispectral imaging system may be configured to use both carriers with and without an added pigment. Thus, the multispectral imaging system may be configured to generate and process the image data representative of a tissue sample using different techniques depending on the particular carrier composition used to carry the tissue sample.

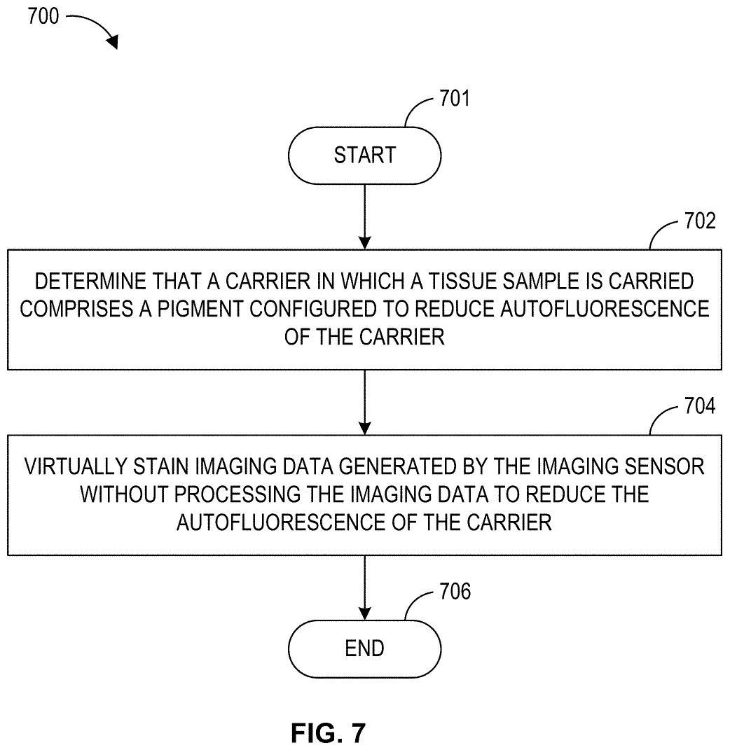

FIG. 7 is an example method 700 for multispectral imaging of a tissue sample in accordance with aspects of this disclosure. The method 700 may be performed by a multispectral imaging system, such as the system 100 of FIG. 1. Depending on the implementation, the blocks of the method 700 may be performed by different components of the system 100, such as the imaging device 102, the image analysis system 108, and/or the user computing device 110. For simplicity, aspects of the method 700 will be described simply as performed by the multispectral imaging system 100.

The method 700 begins at block 701. At block 702, the multispectral imaging system determines that a carrier in which the tissue sample is carried comprises a pigment configured to reduce autofluorescence of the carrier. In some implementations, the determination may be based on an input received from a user, for example, via the user computing device 110. In these implementations, the user may provide an instruction to the multispectral imaging system 100 indicating that the carrier includes the pigment. In other implementations, the multispectral imaging system 100 may be configured to automatically determine whether the carrier includes the pigment. For example, the image analysis system 108 may be configured to determine whether the image data produced from scanning a tissue sample includes a threshold number of pixels having frequencies that are associated with autofluorescence of a carrier. In still other implementations, the identification information 312 associated with a given tissue sample may include information indicative of whether the carrier includes a pigment configured to reduce carrier autofluorescence.

At block 704, the multispectral imaging system virtually stains the imaging data generated by the imaging sensor without processing (e.g., filtering specific frequencies) the imaging data to reduce the autofluorescence of the carrier in response to the determination made in block 702. By refraining from filtering the image data, the multispectral imaging system can more quickly process the image data without losing cellular structure information associated with the filtered frequencies. The method 700 ends at block 706.

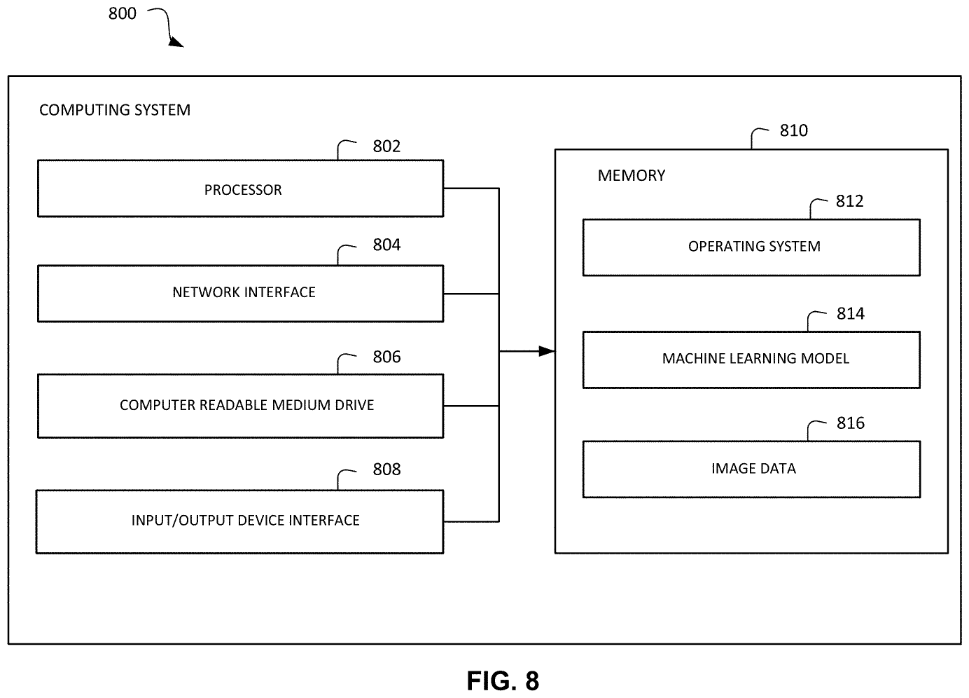

FIG. 8 is an example computing system 800 which can implement any one or more of the imaging device 102, image analysis system 108, and user computing device 110 of the multispectral imaging system illustrated in FIG. 1. The computing system 800 includes a processor 802, a network interface 804, a computer readable medium drive 806, an input/output device interface 808, and a memory 810. The processor 802 may be configured to execute instructions stored on the memory 810 to perform one or more of the blocks described in connection with FIGS. 6 and 7. The network interface 804 may be configured to interface with a network (e.g., the network 112 of FIG. 1) to communicate data between various computing systems 800. The computer readable medium drive 806 may be configured to read and/or write data from an external computer readable medium. The input/output device interface 808 may be configured to display information to a user and/or receive inputs from a user via one or more peripherals (e.g., a display, speaker(s), keyboard, mouse, etc.).

The memory 810 may be configured to store instructions thereon for causing the processor 802 to perform one or more of the blocks described in connection with FIGS. 6 and 7. In the embodiment of FIG. 8, the memory 810 includes an operating system 812, a machine learning model 814, and image data 816. However, depending on the implementation, the memory 810 may include additional instructions or fewer instructions from those illustrated in FIG. 8.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes can be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures can be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

Directional terms used herein (e.g., top, bottom, side, up, down, inward, outward, etc.) are generally used with reference to the orientation shown in the figures and are not intended to be limiting. For example, the top surface described above can refer to a bottom surface or a side surface. Thus, features described on the top surface may be included on a bottom surface, a side surface, or any other surface.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method steps.

The above description discloses several methods and materials of the present invention(s). This invention(s) is susceptible to modifications in the methods and materials, as well as alterations in the fabrication methods and equipment. Such modifications will become apparent to those skilled in the art from a consideration of this disclosure or practice of the invention(s) disclosed herein. Consequently, it is not intended that this invention(s) be limited to the specific embodiments disclosed herein, but that it cover all modifications and alternatives coming within the true scope and spirit of the invention(s) as embodied in the attached claims.

What is claimed is:

1. A composition for fixing a tissue sample for multispectral imaging, the composition comprising:
a carrier configured to protect and carry the tissue sample, the carrier having a first autofluorescence level when multispectral light strikes the tissue sample carried by the carrier; and
a pigment combined with the carrier and configured to reduce an autofluorescence property of the carrier such that the carrier has a second autofluorescence level when multispectral light strikes the tissue sample carried by the carrier, the multispectral imaging including providing light to the tissue sample carried by the carrier within a range of frequencies, the second autofluorescence level being less than the first autofluorescence level, and the second autofluorescence having a frequency that is outside of a range of frequencies of the multispectral imaging,
wherein the pigment is further configured to reduce the first autofluorescence of the carrier in at least a part of the range of frequencies.

2. The composition of claim 1, wherein the carrier comprises a paraffin wax.

3. The composition of claim 1, wherein the carrier is configured to infiltrate into the tissue sample in a liquid form and solidify such that the tissue sample is embedded therein to allow the tissue sample to be sectioned for the multispectral imaging.

4. The composition of claim 1, wherein the pigment is further configured to absorb light having frequencies within a range of frequencies of the multispectral imaging.

5. The composition of claim 1, wherein the pigment is configured so as to not substantially affect the properties of the carrier with regard to infiltrate and carry the tissue sample.

6. The composition of claim 1, wherein the carrier is configured to fix and prevent degradation of the tissue sample during the multispectral imaging.

7. The composition of claim 1, wherein the reduction of the autofluorescence property of the carrier to the second autofluorescence level is configured to improve clarity of an image signal collected from the tissue sample using the multispectral imaging.

8. A multispectral imaging system for acquiring an image of a tissue sample, the system comprising:
a light source configured to emit multispectral light onto the tissue sample, the tissue sample configured to emit at least a portion of the multispectral light received from the light source;
an imaging sensor configured to detect the multispectral light from the tissue sample and generate imaging data based on the detected multispectral light; and
a processor configured to:
determine that a carrier in which the tissue sample is carried comprises a pigment configured to reduce autofluorescence of the carrier, and
in response to determining the carrier comprises the pigment, virtually stain the imaging data generated by the imaging sensor without processing the imaging data to reduce the autofluorescence of the carrier.

9. The system of claim 8, wherein:
the carrier has a first autofluorescence level when multispectral light strikes the tissue sample carried by the carrier,
the reducing of the autofluorescence of the carrier comprises reducing an autofluorescence property of the carrier such that the carrier has a second autofluorescence level when the multispectral light strikes the tissue sample carried by the carrier, the second autofluorescence level being less than the first autofluorescence level, and
the processor is configured to determine that the carrier comprises the pigment in response to detecting the second autofluorescence level.

10. The system of claim 8, wherein the carrier comprises a paraffin wax.

11. The system of claim 8, wherein the carrier is configured to infiltrate into the tissue sample in a liquid form and solidify, wherein the solidifying of the carrier in the tissue sample allows the tissue sample to be sectioned for the multispectral imaging.

12. The system of claim 8, wherein the second autofluorescence has a frequency that is outside of a range of frequencies of the multispectral imaging.

13. The system of claim 8, wherein the pigment is further configured to absorb light having frequencies within a range of frequencies of the multispectral imaging.

14. The system of claim 8, wherein the pigment is configured so as to not substantially affect the properties of the carrier with regard to infiltrate and carry the tissue sample.

15. The system of claim 8, wherein the carrier is configured to fix and prevent degradation of the tissue sample during the multispectral imaging.

16. The system of claim 8, wherein the reduction of the autofluorescence property of the carrier to the second autofluorescence level is configured to improve clarity of an image signal collected from the tissue sample using the multispectral imaging.

17. A non-transitory computer-readable medium having stored thereon instructions which, when executed by a hardware processor, cause the hardware processor to:
determine, by a processor of a multispectral imaging system, that a carrier in which a tissue sample is carried comprises a pigment configured to reduce autofluorescence of the carrier, the multispectral imaging system comprising a light source configured to emit multispectral light onto the tissue sample, the tissue sample configured to emit at least a portion of the multispectral light received from the light source, and an imaging sensor configured to detect the multispectral light from the tissue sample and generate imaging data based on the detected multispectral light; and
in response to determining the carrier comprises the pigment, virtually stain the imaging data generated by the imaging sensor without processing the imaging data to reduce the autofluorescence of the carrier.

18. A method of acquiring an image of a tissue sample, comprising:
determining, by a processor of a multispectral imaging system, that a carrier in which the tissue sample is carried comprises a pigment configured to reduce autofluorescence of the carrier, the multispectral imaging system comprising a light source configured to emit multispectral light onto the tissue sample, the tissue sample configured to emit at least a portion of the multispectral light received from the light source, and an imaging sensor configured to detect the multispectral light from the tissue sample and generate imaging data based on the detected multispectral light; and
in response to determining the carrier comprises the pigment, virtually staining the imaging data generated by the imaging sensor without processing the imaging data to reduce the autofluorescence of the carrier.
